(19) United States
(12) Patent Application Publication
(10) Pub. No.: US 2018/0126489 A1
(43) Pub. Date: May 10, 2018

(54) IN-SITU LASER MACHINING USING MIRRORED OPTICS

(71) Applicant: General Electric Company, Schenectady, NY (US)

(72) Inventors: Mark Marshall Meyers, Halfmoon, NY (US); David Scott Diwinsky, West Chester, OH (US); Duncan Spalding Pratt, Niskayuna, NY (US)

(21) Appl. No.: 15/343,565

(22) Filed: Nov. 4, 2016

(51) Int. Cl. B23K 26/06; F01D 25/24; F01D 9/02; F04D 29/52; F23R 3/00; B23K 26/00; B23K 26/14; B23K 26/40

(52) U.S. Cl. CPC B23K 26/0643; B23K 2201/001; F01D 9/02; F04D 29/522; F23R 3/002; B23K 26/0096; B23K 26/14; B23K 26/40; F05D 2220/32; F05D 2230/13; F05D 2240/35; F05D 2300/171; F05D 2300/174; F05D 2300/177; F01D 25/24

(57) ABSTRACT

The present disclosure is directed to a system for performing in-situ laser machining on a component within a gas turbine engine, in which the component includes a substrate defining a surface. The system includes a laser system disposed externally of the gas turbine engine, a focusing optic, and a conduit. The laser system includes a laser unit that produces an output beam. The focusing optic is disposed between the laser unit and the component. The conduit defines a first end external of the engine and a second end that ingresses into the engine through an access port. The conduit includes a plurality of mirrors within the conduit. The plurality of mirrors directs the output beam from the laser system onto the component.

### FIELD

The present subject matter relates generally to a system and method for performing in-situ machining of a component within a gas turbine engine.

### BACKGROUND

A gas turbine engine typically includes a compressor section, a combustion section, and a turbine section in serial flow relationship. The engine is operable in a known manner to generate a primary gas flow. The compressor section includes annular arrays (“rows”) of stationary vanes that direct air entering the engine into downstream, rotating blades of the compressor. Collectively one row of compressor vanes and one row of compressor blades make up a “stage” of the compressor. Similarly, the turbine section includes annular rows of stationary vanes that direct the gases exiting the combustor into downstream, rotating blades of the turbine. Collectively, one row of vanes and one row of blades make up a “stage” of the turbine. Typically, both the compressor and turbine include a plurality of successive stages.

Gas turbine engines, including those for aircraft, industrial, and marine apparatuses, require periodic maintenance, repair, or modification. For example, periodic maintenance is often scheduled to allow internal components of and within the engine to be inspected for defects and subsequently repaired or otherwise modified. Unfortunately, many conventional repair or modification methods used for gas turbine engines require that the engine be removed from its apparatus (e.g. an aircraft) and subsequently partially or fully disassembled. As such, these repair and modification methods result in a significant increase in both the time and the costs associated with repairing internal engine components.

Therefore, there exists a need for a system and method for repairing or modifying internal gas turbine engine components while minimizing or eliminating partial or full disassembly of the gas turbine engine pursuant to the repair or modification.

### BRIEF DESCRIPTION

Aspects and advantages of the invention will be set forth in part in the following description, or may be obvious from the description, or may be learned through practice of the invention.

The present disclosure is directed to a system for performing in-situ laser machining on a component within a gas turbine engine, in which the component includes a substrate defining a surface. The system includes a laser system disposed externally of the gas turbine engine, a focusing optic, and a conduit. The laser system includes a laser unit that produces an output beam. The focusing optic is disposed between the laser unit and the component. The conduit defines a first end external of the engine and a second end that ingresses into the engine through an access port. The conduit includes a plurality of mirrors within the conduit. The plurality of mirrors directs the output beam from the laser system onto the component.

A further aspect of the present disclosure is directed to a method for performing in-situ laser machining of a component within a gas turbine engine. The in-situ laser machining includes a system including a laser system and a conduit including a plurality of mirrors. The method includes ingressing the conduit into the gas turbine engine, positioning the plurality of mirrors of the conduit relative to the component, transmitting the desired output beam from the laser system, and directing the output beam from the laser system through the conduit to the desired location on the component within the gas turbine engine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross sectional schematic view of one embodiment of a gas turbine engine and an in-situ laser machining system;

FIG. 2 is a schematic view of an exemplary embodiment of the in-situ laser machining system within a gas turbine engine combustion section;

FIG. 3A is a schematic view of another exemplary embodiment of the in-situ laser machining system in a first position;

FIG. 3B is a schematic view of another exemplary embodiment of the in-situ laser machining system in a second position;

FIG. 4 is a schematic view of yet another exemplary embodiment of the in-situ laser machining system;

FIG. 5 is a schematic view of still another exemplary embodiment of the in-situ laser machining system;

FIG. 6 is a schematic view of an exemplary embodiment of the in-situ laser machining system including a heat exchanger; and

FIG. 7 is a flowchart of a method of in-situ laser machining on an internally mounted gas turbine engine component.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Systems and methods of in-situ laser machining of a component within a gas turbine engine using mirrored optics are generally provided. The system includes a laser system disposed externally of the gas turbine engine, including a laser that produces an output beam, and a conduit. The conduit includes a plurality of mirrors within the conduit. The plurality of mirrors directs the output beam from the laser to a desired location and orientation in proximity onto a component within the gas turbine engine. The component may refer generally to a part or assembly within the gas turbine engine. The method of performing in-situ laser machining of a component within a gas turbine engine includes ingressing a conduit into the gas turbine engine, positioning a plurality of mirrors of the conduit relative to the component, transmitting the desired output beam from the laser system, and emitting the output beam from the laser system through the conduit onto the component within the gas turbine engine. In various embodiments, the laser system includes a galvanometer system, a dynamic focusing unit, and/or one or more F-theta lenses in serial arrangement with the laser and the plurality of mirrors within the conduit.

The systems and methods provided herein of in-situ laser machining of the component within the gas turbine engine using mirrored optics may provide benefits over other systems and methods. For example, the systems and methods may obviate the need to remove the gas turbine engine from an aircraft to repair or modify components internal to the gas turbine engine. As another example, the systems and methods may obviate the need to partially or fully disassemble the gas turbine engine to access, repair, or modify the component. As yet another example, the systems and methods may reduce or mitigate the extent of disassembly to repair or modify a component within the gas turbine engine (i.e. reduce from a full disassembly to a partial disassembly, or reduce the magnitude of a partial disassembly). As still another example, the systems and methods described herein may unclog, expand, or add orifices, such as cooling holes, to the component while assembled within the gas turbine engine. As still yet another example, the systems and methods may perform machining to remove high-stress features resulting from component use and deterioration while the component remains installed within the gas turbine engine (e.g. blending cracks, dings, nicks, or other aberrations on the component).

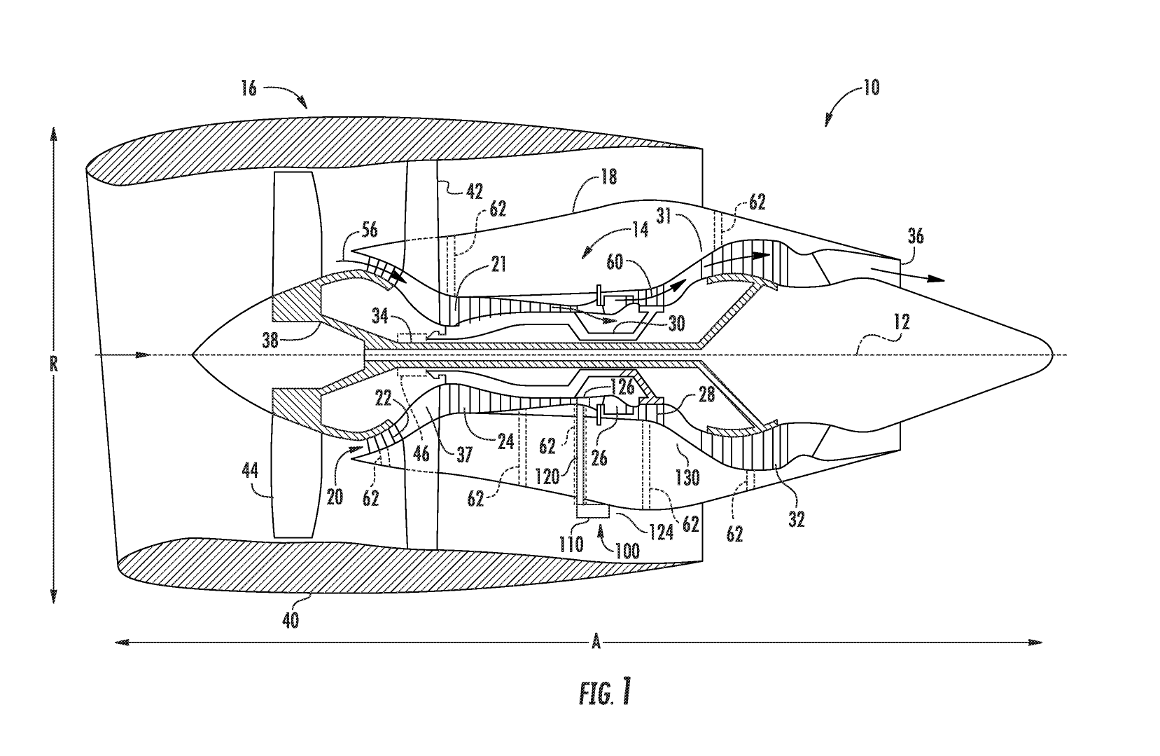

Referring now to the drawings, FIG. 1 is a schematic cross-sectional view of an in-situ laser machining system 100 and a gas turbine engine 10 (herein referred to as “system 100” and “engine 10”, respectively). The system 100 may perform laser machining on a component 130 within the engine 10, including, but not limited to, drilling, welding, boring, or cutting. The component 130 may refer generally to a part or assembly within the internal structure of the engine 10. More specifically, the system 100 may perform laser machining on the component 130 within or internal to the engine 10 while the engine 10 is mounted onto an apparatus, such as an aircraft or vessel. Furthermore, the system 100 may perform laser machining on the component 130 while assembled within the engine 10. Although described further below generally with reference to a turbofan engine, the present subject matter is also applicable to turbomachinery in general, including turbojet, turboprop, and turboshaft engines, including industrial and marine turbine engines and auxiliary power units. Additionally, the present subject matter may be implemented with a gas turbine engine installed to or uninstalled from an apparatus, such as an aircraft, a vessel, or a powerplant.

As shown in FIG. 1, the engine 10 defines an axial direction A (extending parallel to a longitudinal centerline 12 provided for reference) and a radial direction R. In general, the engine 10 includes a fan section 16 and a core engine 14 disposed downstream from the fan section 16. The exemplary core engine 14 depicted generally includes a substantially tubular outer casing 18 that defines an annular inlet 20. The outer casing 18 encases, in serial flow relationship, a compressor section 21 including a low pressure (LP) compressor 22 and a high pressure (HP) compressor 24; a combustion section 26; a turbine section 31 including a high pressure (HP) turbine 28 and a low pressure (LP) turbine 32; and a jet exhaust nozzle section 36. A high pressure (HP) shaft or spool 30 drivingly connects the HP turbine 28 to the HP compressor 24. A low pressure (LP) shaft or spool 34 drivingly connects the LP turbine 32 to the LP compressor 22. The compressor section 21, combustion section 26, turbine section 31, and nozzle section 36 together define a core air flowpath 37. The fan section 16 includes an annular fan casing or outer nacelle 40 that circumferentially surrounds a fan 38 and/or at least a portion of the core engine 14. The nacelle 40 may be supported relative to the core engine 14 by a plurality of circumferentially-spaced outlet guide vanes 42.

The exemplary engine 10 further includes a plurality of access ports 62 defined through its casings and/or frames for providing access to components 130 within the internal structure of the engine 10. The embodiment of the engine 10 shown in FIG. 1 includes a plurality of access ports 62 extending from outside of the engine 10 and the core engine 14 inward along radial direction R. The plurality of access ports 62 defined through the outer casing 18 provide internal access to the engine 10, such as, but not limited to, through the fan section 16, including the power gearbox 46; the compressor section 21; the combustion section 26; the turbine section 31; the jet exhaust nozzle section 36; or areas therebetween, or externally mounted pipes, conduits, reservoirs, gearboxes, heat exchangers, etc.

In several embodiments, the access ports 62 may be spaced apart along the axial direction A along the core engine 14. For instance, the access ports 62 may be spaced apart along each compressor 22, 24, or each turbine 28, 32, or the combustion section 26 along the axial direction A such that at least one access port 62 is located at each compressor or turbine stage (i.e. each set of vanes or blades) or the combustion section 26 for providing access to the components 130 within the internal structure of the engine 10. In addition, the access ports 62 may also be spaced apart circumferentially around the engine 10. For instance, a plurality of access ports 62 may be spaced apart circumferentially around each compressor stage and/or turbine stage.

In various embodiments, the access ports 62 may be dedicated features designed specifically to ingress a conduit, such as borescope inspection ports. In other embodiments, the access ports 62 may include ingress features designed for another function, of which ingress into the engine 10 may be accessible with partial disassembly or displacement of the parts attached to the access ports 62. For example, the access ports 62 may include openings from fuel nozzles, igniters, probes or instrumentation, or fuel, air, or oil manifolds.

The system 100 shown and described herein may laser machine a component 130 including a substrate 135. In one embodiment, the substrate defines a surface 136 onto which a coating may be partially or fully applied. In the embodiment shown in FIGS. 1-6, the component 130 to which the system 100 performs laser machining is an inner liner 52 of a combustor 50 in the combustion section 26. In other embodiments the component 130 may be other parts or assemblies of the combustion section 26, such as an outer liner 54, a bulkhead 56, a turbine nozzle 58, an inner or outer combustion casing 64, 66, or a prediffuser 68. In still other embodiments, the component 130 may be parts or assemblies within the fan section 16, the compressor section 21, the turbine section 31, or the jet exhaust nozzle section 36, such as rotary or stationary airfoils (i.e. blades or vanes), or shrouds (i.e. segments surrounding blades or vanes within a flowpath), casings, or structural members. Although the system 100 is described herein in reference to a combustion section 26 and components therein, the present subject matter includes in-situ laser machining generally within the engine 10, including, but not limited to, the compressors 22, 24, the turbines 28, 32, the fan section 16, and areas therebetween, and externally mounted conduits, modules, or subassemblies.

In one embodiment, the component 130 includes the substrate 135 that defines the surface 136. In various embodiments, the substrate 135 of the component 130 includes a steel or a titanium, or alloys of either, or a nickel-based alloy, or a cobalt-based alloy, or an iron-based alloy, or combinations thereof. In other embodiments, a coating is applied onto the surface 136 of component 130. The surface 136 may be inward or outward on the component 130 along the radial direction R, or extend along the axial direction A, or extend circumferentially, or any portion or combination thereof. In various embodiments, the coating may include a yttria-stabilized zirconia oxide, a nickel aluminide ally, a platinum aluminide alloy, a nickel-chromium-aluminum-yttrium (NiCrAlY) alloy, a cobalt-chromium-aluminum-yttrium (CoCrAlY) alloy, a nickel-cobalt-chromium-aluminum-yttrium (NiCoCrAlY) alloy, or a cobalt-nickel-chromium-aluminum-yttrium (CoNiCrAlY) alloy coating, or combinations thereof. However, in still other embodiments, the substrate 135 may include a ceramic matrix composite or a metal matrix composite.

The present disclosure may refer to areas external or internal of the engine 10. Areas external of the engine 10 may refer generally to all areas by which one of ordinary skill in the art may approach the engine 10 outside of the internally situated component 130. For example, in some configurations of the engine 10 shown in FIG. 1, the fan case or nacelle 40 and/or outer casing 18 may open or otherwise displace and provide more proximate access to the compressor section 21, the combustion section 26, or the turbine section 31. Areas internal or within the engine 10, such as where the component 130 may be disposed, placed, or assembled, may refer generally to areas within the core flowpath 37, or within subsystems or manifolds mounted externally of the engine 10 and the core flowpath 37, or areas within the core engine 14. For example, areas within the core engine 14 may include areas inward of the core flowpath 37 along radial direction R. In still other examples, areas internal or within the engine 10 may include internal surfaces or features of casings, such as the nacelle 40 or the outer casing 18, or other components otherwise not facing outward along the radial direction R.

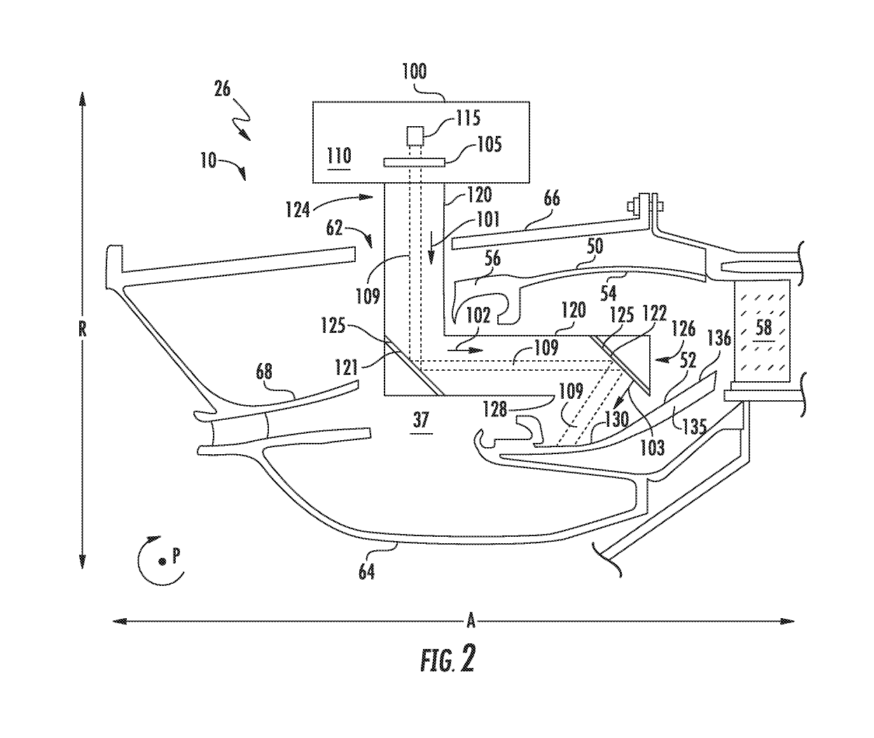

Referring now to FIGS. 1 and 2, the system 100 includes a laser system 110 disposed externally of the engine 10 in which the laser system 110 produces an output beam 109, and a conduit 120. The conduit 120 defines a first end 124 external of the engine 10 and a second end 126 that ingresses into the engine 10 through the access port 62. The conduit 120 includes a plurality of mirrors 125 within the conduit 120. The plurality of mirrors 125 directs the output beam 109 from the laser system 110 onto the component 130 within the engine 10. The component 130 may refer generally to a part or assembly within or internal of the engine 10. For example, the component 130 may be a part or assembly within the fan section 16, the compressor section 21, the combustion section 26, the turbine section 31, or the nozzle section 36, or areas therebetween along the axial direction A or radial direction R.

In one embodiment of the system 100, the conduit 120 is a pathway onto which the plurality of mirrors 125 is placed to direct the output beam 109 onto the component 130 at a desired location and orientation. For example, the conduit 120 may include a discrete alignment of the plurality of mirrors 125 in serial arrangement relative to the laser system 110 and the component 130. The discrete arrangement of the plurality of mirrors 125 may direct the output beam 109 from the laser system 110 external of the engine 10 to the component 130 internal or within the engine 10.

In another embodiment, the conduit 120 is a plurality of walls defining a passage. For example, the plurality of walls may be a tube or manifold. The conduit 120 further defines an outlet 128 at the second end 126 through which the output beam 109 of the laser system 110 emits onto the component 130. The conduit 120 may ingress through the access ports 62 to position the outlet 128 of the conduit 120 in proximity to the component 130 within the engine 10 without disassembling other engine components.

Referring still to FIG. 2, in one embodiment of the system 100 the conduit 120 includes at least two mirrors to direct the output beam 109 to a desired location and orientation onto the component 130. A first mirror 121 may direct the output beam 109 from a first direction 101 from the laser system 110 to a second direction 102 toward a second mirror 122. The second mirror 122 may direct the output beam 109 from the second direction 102 to a third direction 103, in which the third direction 103 is the desired location and orientation of the output beam 109 onto the component 130. In other embodiments, the conduit 120 may include additional mirrors to direct, position, orient, or otherwise condition the output beam 109 to the desired location, orientation, size, and magnitude onto the component 130. The desired location, orientation, size, and magnitude may individually or collectively refer to a diameter of the output beam 109 or of a resulting hole or bore into the component 130, a depth of machining (e.g. the depth of a hole or bore into the component 130), or an angle or position of the output beam 109 to the component 130 along the axial direction A, the radial direction R, or a circumferential direction.

In other embodiments, one or more of the plurality of mirrors 125 may include one or more prisms, lenses, or other optical objectives in addition to or alternatively to mirrors. In still other embodiments, one or more of each of the plurality of mirrors 125 may individually translate, rotate, or change angular position within the conduit 120 relative to another of the plurality of mirrors 125, the component 130, and/or the laser system 110. For example, each of the plurality of mirrors 125 may pivot about a pitch axis P relative to each of the respective plurality of mirrors 125. Each of the plurality of mirrors 125 may pivot from a center or off-center of each of the respective plurality of mirrors 125. As another non-limiting example, each of the plurality of mirrors 125 may translate along axial direction A or radial direction R.

In various embodiments, the laser system 110 includes a laser unit 115 producing the output beam 109. The laser system 110, including the laser unit 115, may be configured based on a desired task, such as drilling, welding, cutting, boring, marking, heat treating or surface finishing, or other surface treatments, or other forms of laser machining or material removal. Additionally, or alternatively, the laser system 110 may be configured based on a desired material, such as a metal, non-metal, or composite, as well as dimensions thereof. Still further, the laser system 110 may be configured based on the desired dimensions of the desired task, such as a depth or distance of cut, a hole diameter, or a type of welding, soldering, or bonding, or a combination thereof.

The laser system 110 may emit the output beam 109 in one or more wavelength ranges, or a combination thereof. For example, the output beam 109 may define a wavelength range of approximately 400 nm or less (e.g. the ultraviolet light spectrum), or approximately 400 nm to approximately 700 nm (e.g. the visible light spectrum), or approximately 700 nm to approximately 1.5 micrometers (e.g. the near infrared light spectrum), or approximately 1.5 micrometers or greater (e.g. the mid-infrared light spectrum).

In still other embodiments, the laser system 110 may define an average power output of the output beam 109. For example, the average power output of the output beam 109 may range from approximately 1 Watt or less to approximately 100 kilowatts. In yet other embodiments, the laser system 110 may define a mode of operation. For example, the mode of operation may include a continuous wave, quasi-continuous wave, or pulsed operation of the laser unit 115. Still further, a pulsed operation of the laser unit 115 may include defining a pulse duration. In various embodiments, the pulse duration may range from about 10 picoseconds to about 1000 nanoseconds. In still other embodiments, the laser system 110 may define a beam mode, a polarization, turnability or power adjustability, and/or linewidth.

The system 100 may further include one or more focusing optics 105 disposed between the laser unit 115 and the component 130. The focusing optic(s) 105 may generally be a lens, prism, mirror, or plurality or combination thereof that focuses the output beam 109 onto the component 130. In various embodiments, the focusing optic 105 may define a collimator, a galvanometer system, an F-theta objective, a dynamic focusing unit, or combinations thereof.

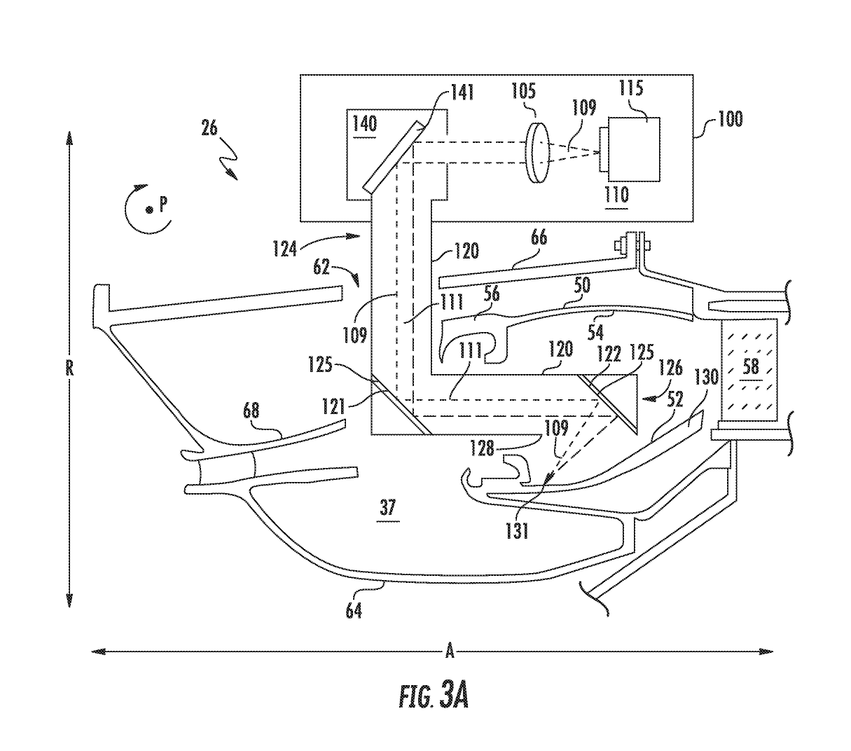

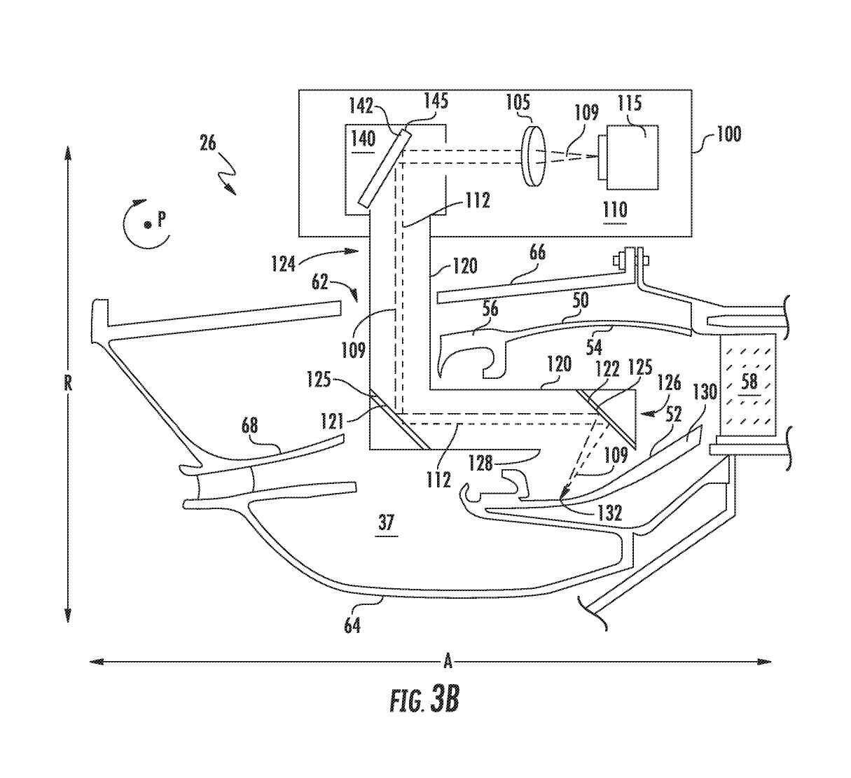

Referring now to FIGS. 3A and 3B, the laser system 110 may include a galvanometer system 140 in serial arrangement with the laser unit 115 and the plurality of mirrors 125 within the conduit 120. The galvanometer system 140 may set a desired focus, position, orientation, and/or magnitude of the output beam 109 of the laser system 110 relative to the plurality of mirrors 125 of the conduit 120. For example, the plurality of mirrors 125 within the conduit 120 may be positioned and oriented in proximity to the component 130 within the engine 10. Furthermore, the galvanometer system 140 may further guide the output beam 109 from the laser unit 115 in addition to or in lieu of further adjustments to the position and orientation of the plurality of mirrors 125.

In one embodiment, as shown in FIGS. 3A and 3B, the laser system 110 may include one or more focusing optics 105 defining a collimator to narrow, collimate, make parallel, or otherwise align the output beam 109 in a specific direction. For example, as shown in FIGS. 3A and 3B, the focusing optic 105, including a collimator, narrows and aligns the output beam 109 dispersed from the laser unit 115 toward the galvanometer system 140. In various embodiments, the collimator may include a curved mirror or lens. In other embodiments, the laser unit 115 may include one or more collimators to narrow or align the output beam 109 from the laser unit 115 toward the component 130 or another focusing optic 105 therebetween.

The galvanometer system 140 may include at least one galvanometer mirror 145, an actuator, and a positioning detection means for the galvanometer mirror 145. The actuator may adjust a load placed on the galvanometer mirror 145 from the output beam 109 of the laser system 110. The positioning detection means for the galvanometer mirror 145 may set or adjust the orientation of the galvanometer mirrors 145 based on a desired output beam load, focus, and/or orientation relative to the plurality of mirrors 125 of the conduit 120 and the component 130. The positioning detection means of the galvanometer system 140 may further include a servo driver to control the output beam load onto the galvanometer mirror 145 relative to the orientation or position of the galvanometer mirror 145. The galvanometer system 140 may alter and direct the output beam 109 from the laser unit 115 to a plurality of locations on the component 130.

In various embodiments, the positioning detection means and/or the servo driver may rotate the galvanometer mirror 145 about a pitch axis P to alter the position and/or orientation of the output beam 109 relative to its contact to the component 130. As shown in FIGS. 3A and 3B, the pitch axis P for the galvanometer mirror 145 may be defined approximately at a center of the galvanometer mirror 145. In other embodiments, the galvanometer mirror 145 may be defined off-center. In still other embodiments, the galvanometer mirror 145 may translate or rotate about radial direction R or axial direction A.

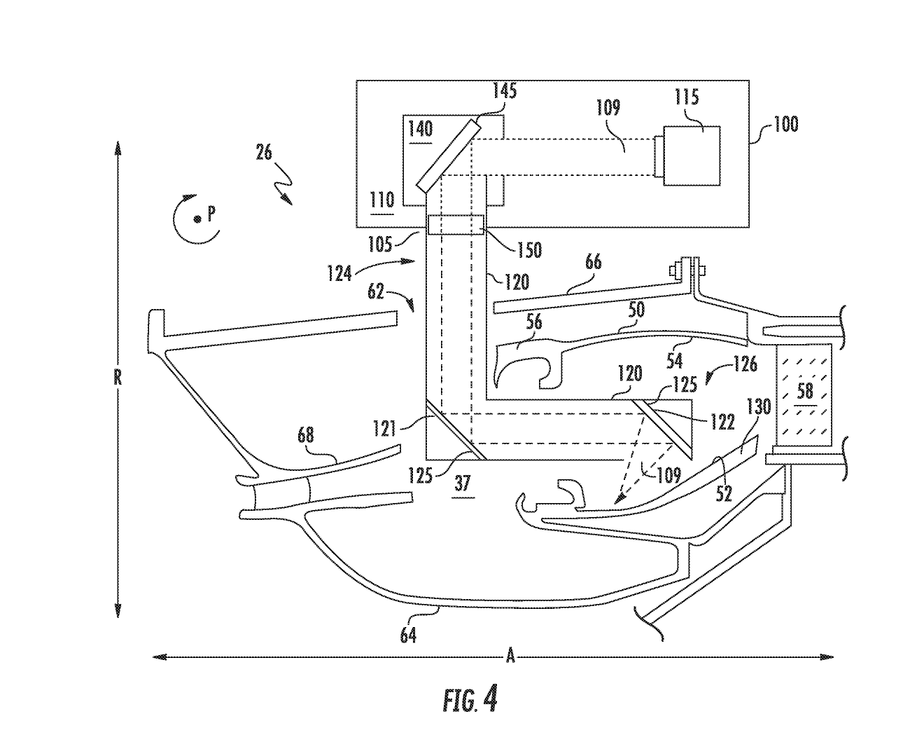

In one embodiment, the galvanometer system 140 may be a two-dimensional galvanometer system 140 including one or more galvanometer mirrors 145 and an F-theta objective 150, in which the F-theta objective 150 is disposed between at least one galvanometer mirror 145 and the plurality of mirrors 125 of the conduit 120 (shown in FIG. 4). In another embodiment, the galvanometer system 140 may be a three-dimensional galvanometer system 140 including a dynamic focusing unit 160 disposed between the laser unit 115 and one or more galvanometer mirrors 145. In various embodiments, the galvanometer system 140 may deflect the output beam 109 in the axial direction A and in the radial direction R, or combinations thereof.

The embodiment of the system 100 including the galvanometer system 140 shows the galvanometer system 140 rotating to a plurality of positions to define alternative paths of the output beam 109. As shown in FIG. 3A, a first position 141 of the galvanometer mirror 145 shows the output beam 109 following a first path 111 from the galvanometer mirror 145 to the plurality of mirrors 125 of the conduit 120, and from the plurality of mirrors 125 to a first location 131 on the component 130. As shown in FIG. 3B, a second position 142 of the galvanometer mirror 145 shows the output beam 109 follow a second path 112 from the galvanometer mirror 145 to a second location 132 on the component 130. The examples and embodiments shown in FIGS. 3A and 3B of the first and second positions 141, 142 of the galvanometer mirror 145 and the first and second locations 131, 132 on the component 130 are provided by way of illustration and are not intended to limit the movement of the system 100 or the output beam 109 to the discrete positions shown in the figures.

Referring now to FIG. 4, another exemplary embodiment of an in-situ laser machining system 100 is provided. The system 100 may be configured substantially similarly as the system 100 shown and described in regard to FIGS. 1-3. The system 100 shown in FIG. 4 may further include the F-theta objective 150. The F-theta objective 150 may include a plurality of flat and/or curved lenses spaced apart and separated by a gas. The F-theta objective 150 may be positioned in serial arrangement between the laser unit 115 and the plurality of mirrors 125 of the conduit 120. In one embodiment, as shown in FIG. 4, the F-theta objective 150 is positioned in serial arrangement between the galvanometer system 140 and the plurality of mirrors 125 of the conduit 120. In another embodiment, the F-theta objective 150 may be positioned between the plurality of mirrors 125 of the conduit 120 and the component 130. In still another embodiment, the F-theta objective 150 may be positioned between the first mirror 121 and the second mirror 122 of the conduit 120.

The F-theta objective 150 may provide a calibrated amount of distortion to the output beam 109 such that each location on the component 130 (e.g. first and second location 131, 132 shown in FIG. 3A and FIG. 3B, respectively) receive the output beam 109 of similar characteristics. For example, the F-theta objective 150 may distort the output beam 109 to compensate or correct for changes in depth of cut, diameter, and/or intensity of the output beam 109 as the output beam 109 changes locations (e.g. as shown at the locations 131, 132 in FIG. 3A and FIG. 3B, respectively) on the component 130.

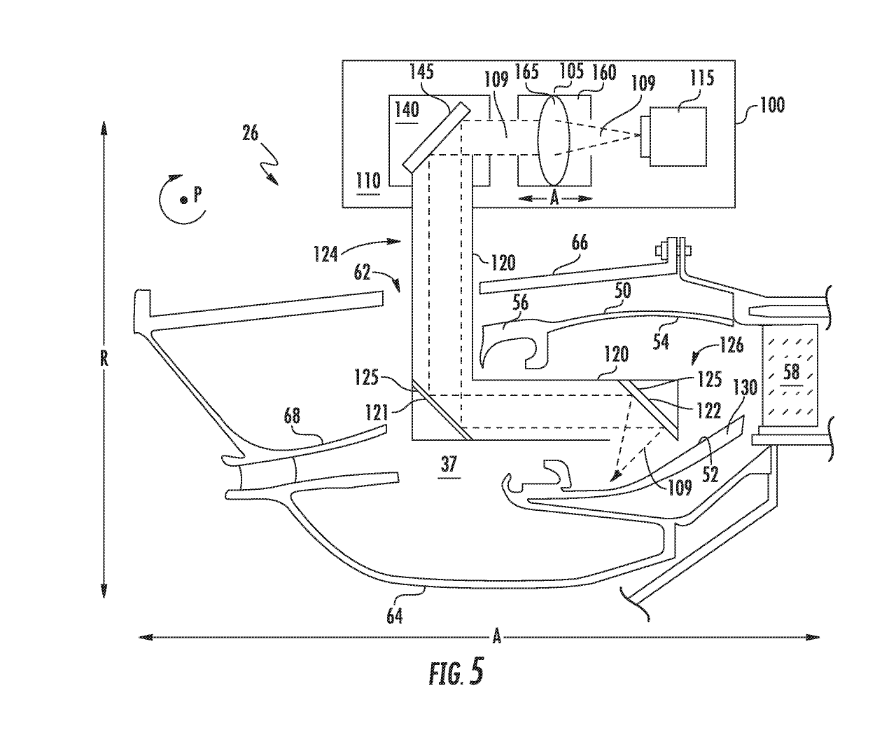

Referring now to FIG. 5, another exemplary embodiment of an in-situ laser machining system 100 is provided. The system 100 shown in FIG. 5 may be configured substantially similarly as the system 100 shown and described in regard to FIGS. 1-4. The laser system 100 shown in FIG. 5 may further include the dynamic focusing unit 160 in serial arrangement with the laser system 110 and the plurality of mirrors 125 of the conduit 120. In the embodiment shown in FIG. 5, the dynamic focusing unit 160 is positioned in serial arrangement between the laser unit 115 and the galvanometer system 140.

The dynamic focusing unit 160 translates at least one focusing lens 165 along the direction of the output beam 109 of the laser system 110 to adjust the focus or refraction of the output beam 109. For example, in the embodiment shown in FIG. 5, the dynamic focusing unit 160 may translate at least one focusing lens 165 along the axial direction A, co-linear to the output beam 109 from the laser unit 115. The dynamic focusing unit 160 may translate the focusing lens 165 within the dynamic focusing unit 160 to adjust the focus or refraction of the output beam 109. The dynamic focusing unit 160 may provide a compensation or correction to maintain an approximately constant output beam 109 diameter, depth of cut, intensity and/or focus as the output beam 109 changes locations on the component 130 (e.g. as shown at the locations 131, 132 in FIG. 3A and FIG. 3B, respectively).

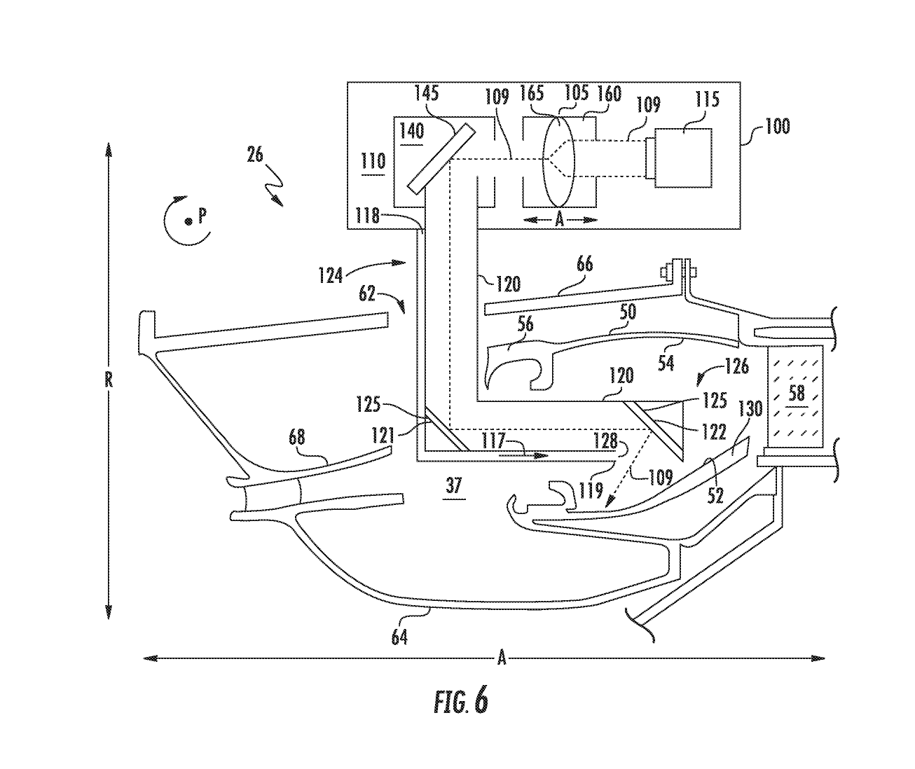

Referring now to FIG. 6, yet another exemplary embodiment of an in-situ laser machining system 100 is provided. In the embodiment shown in FIG. 4, the conduit 120 of the system 100 includes tubes or walls around or within the conduit 120 to further define a fluid passage 118 to flow a fluid 117 around or through the conduit 120. The fluid 117 may include an appropriate refrigerant, such as, but not limited to, air, an inert gas, carbon dioxide, ammonia, a non-halogenated hydrocarbon, water, ethylene glycol, propylene glycol, a hydrofluorocarbon, a chlorofluorocarbon, or a hydrochlorofluorocarbon, or a combination thereof. In one embodiment of the system 100, the fluid passage 118 may flow the fluid 117 through the conduit 120 in closed loop arrangement. In another embodiment, the fluid 117 may flow in the fluid passage 118 in open loop arrangement. The fluid 117 may egress the conduit 120 through a fluid outlet 119 defined proximate to the second end 126. The fluid 117 may provide cooling to the conduit 120, the laser system 110, and/or aid laser machining on the component 130. For example, the fluid 117 may prevent laser drilled holes on the component 130 from re-sealing. As another non-limiting example, the fluid 117 may contact the component 130 and reduce thermal stresses on the component 130 during machining. In still another example, the fluid 117 may impart or remove dust or debris from the component 130.

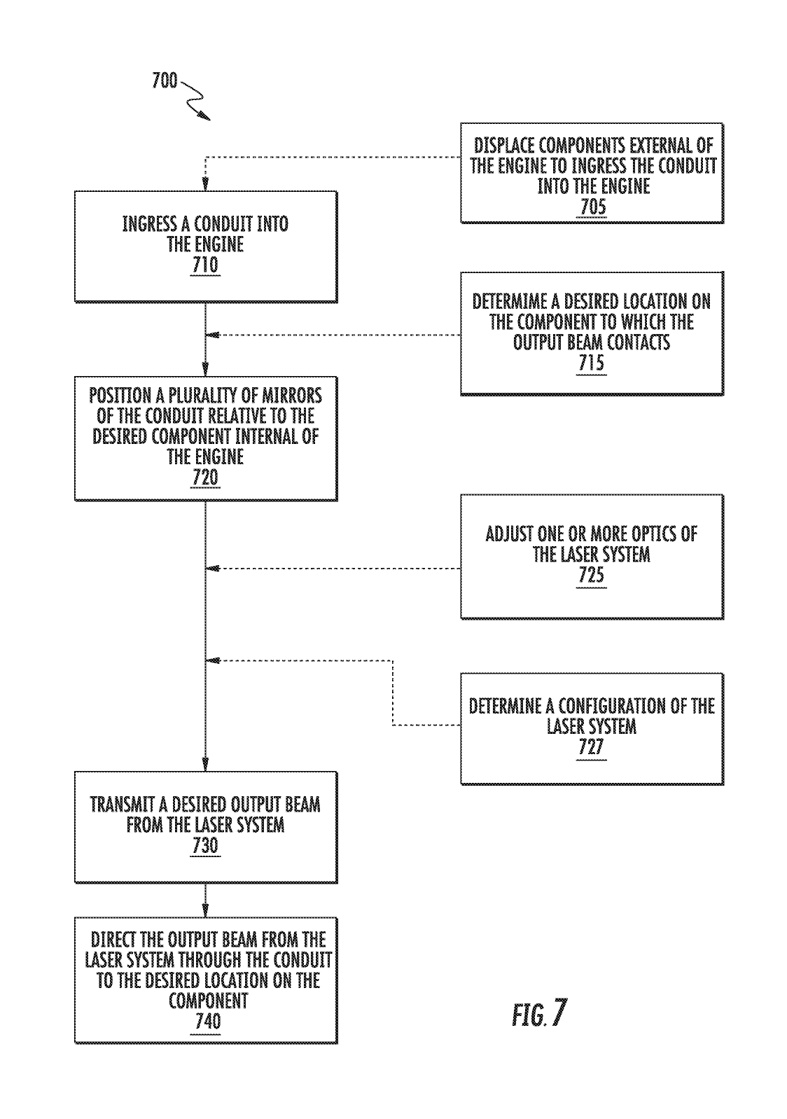

Referring now to FIG. 7, a flow chart of a method for performing in-situ laser machining to a component within a gas turbine engine 700 is provided (herein referred to as “method 700”). The method 700 may be implemented using an in-situ laser machining system such as the system 100 described and shown herein. FIG. 7 depicts steps performed in a particular order for the purposes of illustration and discussion. Those of ordinary skill in the art, using the disclosures provided herein, will understand that various steps of any of the methods disclosed herein can be adapted, modified, rearranged, omitted, or expanded in various ways without deviating from the scope of the present disclosure.

The method 700 can include at (710) ingressing a conduit into an engine. Ingressing the conduit into the engine may further include at (705) displacing components external of the engine to ingress the conduit into the engine. Ingressing the conduit into the engine may further include ingressing the conduit through an access port of the engine, such as the access ports 162 described in regard to FIG. 1. Displacing components external of the engine and ingressing the conduit may include removing borescope plugs, fuel nozzles, fuel, air, or oil manifolds, or displacing the nacelle or other cases of the engine. The conduit may include the conduit 120 including the plurality of mirrors 125 as described herein in regard to FIGS. 1-6.

At (720), the method 700 includes positioning a plurality of mirrors of the conduit relative to a desired component internal of the engine. Positioning the plurality of mirrors, such as those of the system 100, relative to the desired component may include setting a desired angle, distance, or orientation of each of the plurality of mirrors 125 relative to the component 130, each of the respective plurality of mirrors 125 (e.g. the first mirror 121 and second mirror 122), and the laser system 110. At (715), the method 700 may include determining a desired location on the component to which the output beam contacts. Determining the desired location on the component may include determining the component within the engine (e.g. a component in the compressor section 21, or combustion section 26, or turbine section 31, etc.). Determining the desired location on the component may further include determining a coordinate on the component onto which the output beam contacts.

At (730) the method 700 can further include transmitting a desired output beam from the laser system. Transmitting the desired output beam from the laser system may include transmitting the output beam 109 from the laser system 110 in the first direction 101 to the first mirror 121, from the first mirror 121 to the second mirror 122 in the second direction 102, and from the second mirror 122 to the desired location on the component 130 in the third direction 103.

At (725), the method 700 may further include determining a configuration of a laser system, such as the laser system 110 described and shown in regard to FIGS. 1-6. Determining a configuration of the laser system 110 may include determining a wavelength range, a mode of operation, a power output, power turnability or adjustability, beam mode, polarization, and/or linewidth. Determining a mode of operation may include determining a continuous wave, quasi-continuous wave, or pulsed operation.

At (727), the method 700 may further include adjusting one or more optics of the laser system. Adjusting one or more optics of, e.g. the laser system 110, includes adjusting the galvanometer mirror 145 of the galvanometer system 140, the F-theta objective 150, and/or the focusing lens 165 of the dynamic focusing unit 160. Adjusting one or more optics of the laser system 110 may further include adjusting the pitch axis P, the position along the axial direction A, the position along the radial direction R, and/or the position along a circumferential direction for one or more of the galvanometer mirror 145, the F-theta objective 150, or the focusing lens 165.

At (740), the method 700 can include directing the output beam from the laser system through the conduit to the desired location on the component within the engine. Directing the output beam may include performing the desired laser machining task on the component. For example, directing the output beam onto the component may include drilling, cutting, boring, welding, marking, surface finishing, stress relieving, or cleaning (e.g. burning away dust, debris, or removing clogs, etc.).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for performing in-situ laser machining on a component within a gas turbine engine, wherein the component comprises a substrate defining a surface, the system comprising:
a laser system disposed externally of the gas turbine engine, wherein the laser system comprises a laser unit that produces an output beam;
a focusing optic disposed between the laser unit and the component; and
a conduit defining a first end external of the engine and a second end that ingresses into the engine through an access port, wherein the conduit includes a plurality of mirrors within the conduit, and wherein the plurality of mirrors directs the output beam from the laser system onto the component.

2. The system of claim 1, wherein the laser system further comprises:
a galvanometer system in serial arrangement with the laser unit and the plurality of mirrors of the conduit.

3. The system of claim 1, wherein the focusing optic is an F-theta objective in serial arrangement with the laser system and the plurality of mirrors of the conduit.

4. The system of claim 1, wherein the focusing optic is a dynamic focusing unit in serial arrangement with the laser system and the plurality of mirrors of the conduit.

5. The system of claim 1, wherein the conduit is defined by a plurality of walls defining an outlet at the second end through which the output beam emits onto the component.

6. The system of claim 1, wherein the conduit comprises at least a first mirror and a second mirror to direct the output beam in a desired location and orientation onto the component.

7. The system of claim 6, wherein the first mirror directs the output beam from a first direction to a second direction toward the second mirror, and wherein the second mirror directs the output beam from the second direction to a third direction, and wherein the third direction is the desired location and orientation of the output beam onto the component.

8. The system of claim 1, wherein the conduit further defines a fluid passage to flow a fluid around or through the conduit.

9. The system of claim 8, wherein the conduit further defines a fluid outlet at the second end through which the fluid from the fluid passage egresses at or near the component.

10. The system of claim 1, wherein the substrate of the component includes a steel or a titanium, or alloys of either, or a nickel-based alloy, or a cobalt-based alloy, or an iron-based alloy, or combinations thereof.

11. The system of claim 1, wherein the component further comprises:
a coating on the substrate, wherein the coating includes a yttria-stabilized zirconia oxide, a nickel aluminide ally, a platinum aluminide alloy, a nickel-chromium-aluminum-yttrium (NiCrAlY) alloy, a cobalt-chromium-aluminum-yttrium (CoCrAlY) alloy, a nickel-cobalt-chromium-aluminum-yttrium (NiCoCrAlY) alloy, or a cobalt-nickel-chromium-aluminum-yttrium (CoNiCrAlY) alloy coating, or combinations thereof.

12. A method for performing in-situ laser machining of a component within a gas turbine engine, wherein the in-situ laser machining includes a system including a laser system and a conduit including a plurality of mirrors, the method comprising:
ingressing the conduit into the gas turbine engine;
positioning the plurality of mirrors of the conduit relative to the component;
transmitting the desired output beam from the laser system; and
directing the output beam from the laser system through the conduit to the desired location on the component within the gas turbine engine.

13. The method of claim 12, wherein positioning the plurality of mirrors of the conduit relative to the component includes setting a desired angle, distance, or orientation of each of the plurality of mirrors relative to the component, each of the respective plurality of mirrors, and the laser system 110

14. The method of claim 12, further comprising:
displacing components external of the engine to ingress the conduit into the engine.

15. The method of claim 12, further comprising:
determining a desired location on the component to which the output beam contacts.

16. The method of claim 12, further comprising:
determining a configuration of the laser system.

17. The method of claim 16, wherein determining the configuration of the laser system include determining a wavelength range, a mode of operation, a power output, power turnability or adjustability, beam mode, polarization, and/or linewidth.

18. The method of claim 12, further comprising:
adjusting one or more optics of the laser system.

19. The method of claim 18, wherein adjusting one or more optics of the laser system includes adjusting the pitch axis P, the position along the axial direction A, the position along the radial direction R, and/or the position along a circumferential direction for one or more of the galvanometer mirror, the F-theta objective, or the focusing lens.

20. The method of claim 12, wherein directing the output beam to the desired location on the component includes performing the desired laser machining task on the component.
